(19) United States
(12) Patent Application Publication
(10) Pub. No.: US 2003/0074182 A1
(43) Pub. Date: Apr. 17, 2003

(54) Global communication means

(76) Inventor: Joseph Mathias, Ridgeville (CA)

Correspondence Address: MARK A. KOCH, 866 Main Street East, Hamilton, ON, L8M 1L9, CA

(21) Appl. No.: 09/969,820

(22) Filed: Oct. 4, 2001

(51) Int. Cl. G06F 17/20

(52) U.S. Cl. 704/1

(57) ABSTRACT

A communication means including a global phonetic alphabet consisting of the 30 symbols wherein said alphabet symbols are used to form a computer operating language consisting of the global phonetic alphabet symbols. Preferably said symbols are arranged together to form words wherein each word so formed has only one distinct meaning and one distinct sound. Preferably said words compiled together form a global phonetic language. Preferably said language is adapted for including voice recognition software for communicating orally with computers

### FIELD OF THE INVENTION

The present invention relates to a communication means including phonetic alphabetic symbols and in particular relates to a set of alphabetic symbols which can be used as a global phonetic alphabet.

### BACKGROUND OF THE INVENTION

The current alphabet which consists of 26 letters and in addition to that 10 numerals for the numbers a total of 36 different characters for written and oral communication in the English Language. In addition to this many of the letters and vowels currently found in the English Alphabet, represent more than one sound depending upon the word in which the character is found in. Furthermore, depending upon the word being used some characters found within words can have no sound whatsoever, in other words they are silent letters. There are many irregularities in spelling in regard to pronunciations wherein the exact same spelling can have different sounding depending upon the letters that are associated with a particular neighbouring letter in a word. All this results in a very confusing and difficult language to learn to write and to speak and potentially can result in confusion between parties wanting to correspond clearly and decisively a particular meaning.

The indecisiveness and vagueness of the English Alphabet and language associated with it, furthermore can create indefiniteness particularly when computers are communicating and this especially can cause problems for voice recognition softwares which are currently becoming more and more popular in their use.

Presently, often the same words have many different meanings which can cause mistakes to be made in oral and written language and also mistakes to be made in machine language, for example, when users communicate with computers or when computers communicate with each other. A absolute global phonetic alphabet for example having only one meaning for each word and wherein each letter of the alphabet represents only one sound would make more accurate words and there meaning would improve communication both written orally and through computers.

An absolute global phonetic alphabet which is used for a computer operating system will ensure compatibility in the ability for all computers on this earth to be able to communicate with each other accurately and efficiently.

Computers now use a number of different languages and operating systems to activate thousands of other programs that perform various tasks. None of these operating systems are absolute or global in nature which causes mistakes and computer crashes to occur. Currently programs often need to be translated from one system to another which causes further mistakes and slow downs. An absolute global phonetic alphabet will help prevent such mistakes, speed up computer processing and speed up the time of any translations which may be necessary.

An absolute global phonetic alphabet will allow for people, computers, machines, professionals and governments around the world to understand each other and will help eliminate conflicts and errors in communication.

Computers in particular would be more useful with the global phonetic alphabet since they would be able to respond more accurately and more quickly to oral commands and voice recognition software would be much simpler to develop and become more accurate and faster.

Therefore there is a need to provide a universal global phonetic alphabet that facilitates communication between persons of various backgrounds and also facilitates communication between computers and also enables new technologies to be more quickly introduced.

### SUMMARY OF THE INVENTION

A communication means including a global phonetic alphabet consisting of the symbols shown in FIG. 1.

Preferably wherein said alphabet symbols are used to form a computer operating language consisting of the global phonetic alphabet symbols.

Preferably wherein said symbols are arranged together to form words wherein each word so formed has only one distinct meaning and one distinct sound.

Preferably wherein said words compiled together form a global phonetic language.

Preferably said language is adapted for including voice recognition software for communicating orally with computers

Preferably wherein said alphabet, and words, and language created from said alphabet; are used for communications between people, computers and machines, and by voice, writing, and keyboard, and by cable, wireless, and phone.

### BRIEF DESCRIPTION OF THE DRAWINGS

FIG. 1 lists the complete numbers and letters for a global phonetic alphabet as presented in this application. The following set of alphabet symbols are proposed for a global phonetic alphabet which has 9 vowels which can also be used for the first eleven numerals and in total 30 symbols creating the total phonetic alphabet.

### DETAILED DESCRIPTION OF THE PREFERRED EMBODIMENT

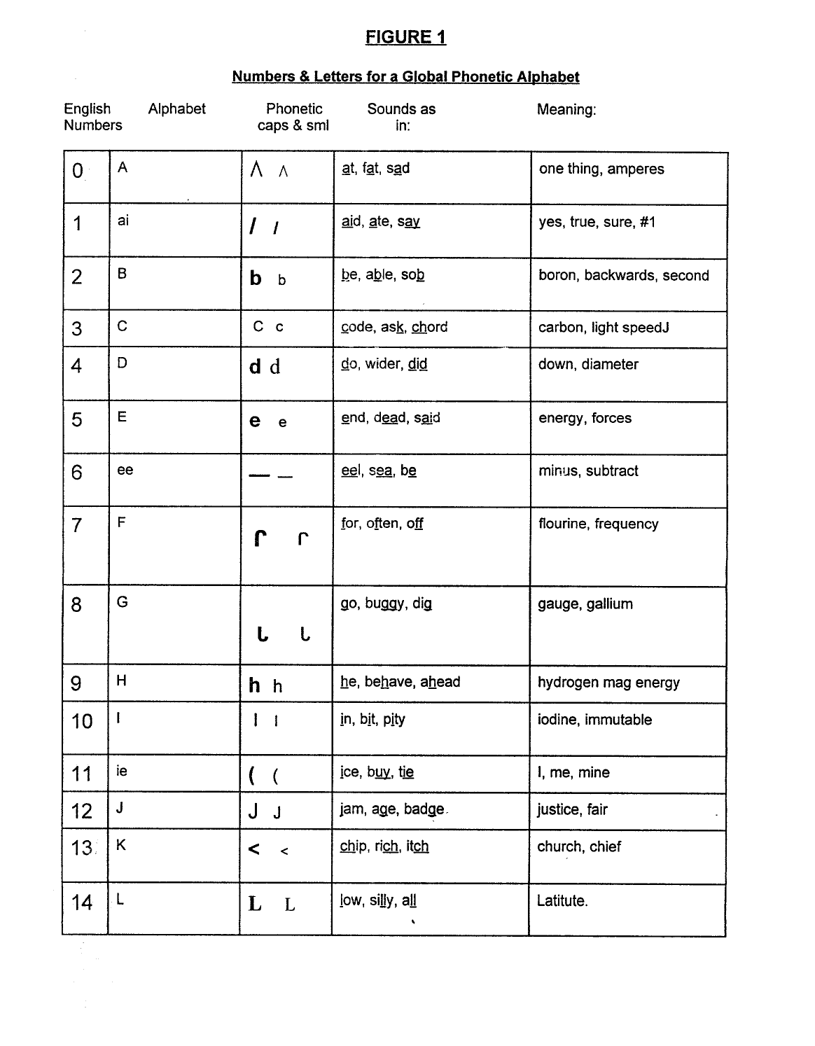

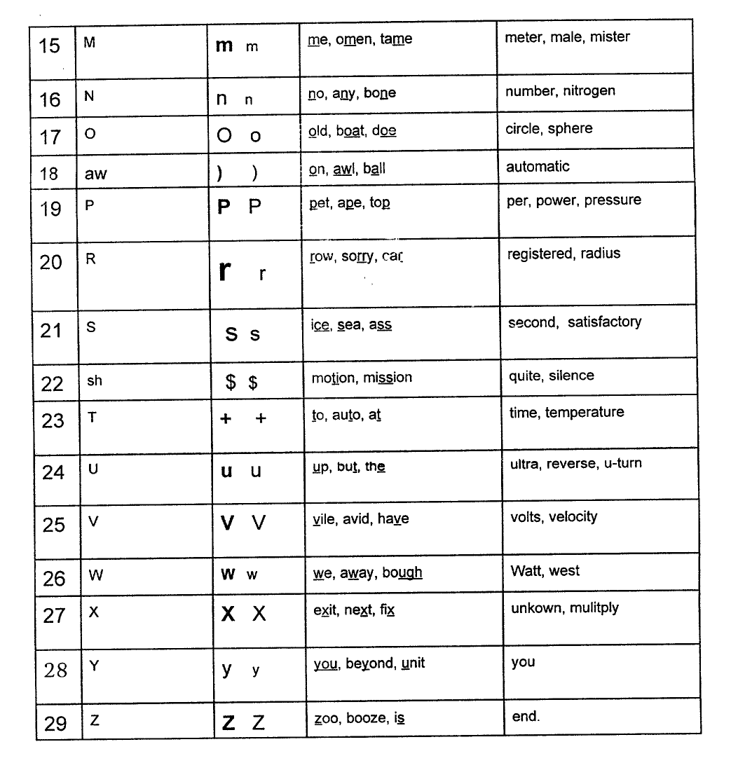

Referring to FIG. 1 the following is a listing of the alphabetical symbols for a global phonetic alphabet. The first eleven symbols represent diphthongs or vowels sounds and the balance represent consonant symbols. Each symbol has a distinctive unaltering sound in and of themselves, and furthermore the sound of each symbol is independent of any surrounding letters.

1. The first symbol being an inverted vee; [symbol] , which represents the sounds as found in the words; at, fat, sad. This symbol may also represent the number 0. This symbol also has attached to it the meanings one thing and amperes.

2. The second alphabetical symbol which is an upward sloping slash; [symbol] /, which represents the sounds as found in the words; aid, ate, say. This symbol may also represent the number 1. This symbol also has attached to it the meanings yes, true, sure and #1.

3. The third alphabetical symbol is the English letter; [symbol] b, which represent the sounds found in the words; be, able, sob. This symbol may also represent the number 2. This symbol also has attached to it the meanings, boron and second.

4. The fourth alphabetical symbol which is the English letter; [symbol] c, which represents the sounds found in the words; code, ask, chord. This symbol may also represent the number 3 This symbol also has attached to it the meanings carbon and light speed.

5. The fifth alphabetical symbol which is the English letter; [symbol] d, which represents the sounds found in the words; do, wider, did. This symbol may also represent the number 4. This symbol also has attached to it the meanings down and diameter.

6. The sixth alphabetical symbol which is the English letter; [symbol] e, which represents the sounds found in the words; end, dead, said. This symbol may also represent the number 5. This symbol also has attached to it the meanings, energy and forces.

7. The seventh symbol which is a straight dash; [symbol] -, which represents the sounds found in the words; eel, sea, be. This symbol may also represent the number 6. This symbol also has attached to it the meanings, minus and subtract.

8. The eight symbol is a reversed and inverted and reversed J; [symbol] , which represents the sounds found in the words; for, often, off. This symbol may also represent the number 7. This symbol also has attached to it the meanings, fluorine and frequency.

9. The ninth symbol is the reversed “J”; [symbol] , which represents the sounds found in the words; go, buggy, dig. This symbol may also represent the number 8. This symbol also has attached to it the meanings, gauge and gallium.

10. The tenth symbol is the English letter; [symbol] h, which represents the sounds found in the words; he, behave, ahead. This symbol may also represent the number 9. This symbol also has attached to it the meanings, hydrogen mag energy.

11. The eleventh alphabetical symbol which is the English letter I; [symbol] , which represents the sounds found in the words; in, bit, pity. This symbol may also represent the number 10. This symbol also has attached to it the meanings, iodine and immutable.

12. The twelfth symbol is a left hand circular bracket; [symbol] (, which represents the sounds found in the words; ice, buy, tie. This symbol may also represent the number 11. This symbol also has attached to it the meanings, I, me and mine.

13. The thirteenth symbol which is the English letter J; [symbol] J, which represents the sounds found in the words; jam, age, badge. This symbol may also represent the number 12. This symbol also has attached to it the meanings, justice and fair.

14. The fourteenth symbol is a left arrow; [symbol] <, which represents the sounds found in the words; chip, rich, itch. This symbol may also represent the number 13. This symbol also has attached to it the meanings, church and chief.

15. The fifteenth symbol is the English letter L: [symbol] L, which represents the sounds found in the words; low, silly, all. This symbol may also represent the number 14. This symbol also has attached to it the meanings, Latitude.

16. The sixteenth symbol is the English letter M; [symbol] m, which represents the sounds found in the words; me, omen, tame. This symbol may also represent the number 15. This symbol also has attached to it the meanings meter, male and mister.

17. The seventeenth symbol is the English letter N; [symbol] n, which represents the sounds found in the words; no, any, bone. This symbol may also represent the number 16. This symbol also has attached to it the meanings number and nitrogen.

18. The eighteenth symbol is the English letter O; [symbol] o, which represents the sounds found in the words; old, boat, doe. This symbol may also represent the number 17. This symbol also has attached to it the meanings circle and sphere.

19. The nineteenth symbol is a curved right hand bracket; [symbol] ), which represents the sounds found in the words; on, awl, ball. This symbol may also represent the number 18. This symbol also has attached to it the meaning automatic.

20. The twentieth symbol is the English letter P; [symbol] , which represents the sounds found in the words; pet, ape, top. This symbol may also represent the number 19. This symbol also has attached to it the meanings per, power, pressure.

21. The twenty-first symbol is the English letter R; [symbol] , which represents the sounds found in the words; row, sorry, car. This symbol may also represent the number 20. This symbol also has attached to it the meanings register and radius.

22. The twenty-second symbol is the English letter S; [symbol] S, which represents the sounds found in the words; ice, sea, ass. This symbol may also represent the number 21. This symbol also has attached to it the meanings second and satisfactory.

23. The twenty-third symbol is the English dollar sign; [symbol] $, which represents the sounds found in the words; motion, mission. This symbol may also represent the number 22. This symbol also has attached to the meanings quiet and silence.

24. The twenty-fourth symbol is a plus sign or a cross; [symbol] +, which represents the sounds found in the words; to, auto, at. This symbol may also represent the number 23. This symbol also has attached to the meanings title and temperature.

25. The twenty-fifth symbol is the English letter U; [symbol] u, which represents the sounds found in the words; up, but, the. This symbol may also represent the number 24. This symbol also has attached to the meanings ultra and U=reverse.

26. The twenty-sixth symbol which is the English letter V; [symbol] , which represents the sounds found in the words; vile, avid, have. This symbol may also represent the number 25. This symbol also has attached to the meanings volts and velocity.

27. The twenty-seventh symbol is the English letter W; [symbol] w, which represents the sounds found in the words; we, away, bough. This symbol may also represent the number 26. This symbol also has attached to the meanings watt and west.

28. The twenty-eight symbol which is the English letter X; XX , which represents the sounds found in the words; exit, next, fix. This symbol may also represent the number 27. This symbol also has attached to the meanings unknown and multiply.

29. The twenty-ninth symbol which is the English letter Y; [symbol] , which represents the sounds found in the words; you, beyond, unit. This symbol may also represent the number 28. This symbol also has attached to the meaning Y=you.

30. The thirtieth symbol which is the English letter Z; [symbol] , which represents the sounds found in the words; zoo, booze, is. This symbol may also represent the number 29. This symbol also has attached to the meaning Z=end.

Each alphabetical symbol is constructed of simple shapes such as straight lines, angled lines, circles, half circles and combinations of these oriented in various directions. This facilitates the simple reproduction of the symbols both by hand and by machines.

In addition the above defined alphabet symbols can be used for the formulation of a universal computer operating language and a universal written and spoken language. Using the above symbols most English words can be translated into a new word constructed from the global phonetic alphabet.

A language created using the global phonetic alphabet is especially useful for voice recognition software application since every sound has only one distinct symbol.

It should be apparent to persons skilled in the arts that various modifications and adaptation of this structure described above are possible without departure from the spirit of the invention the scope of which defined in the appended claim.

I claim:

1. A global communication means including a global phonetic alphabet consisting of the following symbols:
a) The first symbol being an inverted vee .0; [symbol] , which represents the sounds as found in the words; at, fat, sad. This symbol may also represent the number 0. This symbol also has attached to it the meanings one thing and amperes.
b) The second alphabetical symbol which is an upward sloping slash; [symbol] /, which represents the sounds as found in the words; aid, ate, say. This symbol may also represent the number 1. This symbol also has attached to it the meanings yes, true, sure and #1.
c) The third alphabetical symbol is the English letter; [symbol] b, which represent the sounds found in the words; be, able, sob. This symbol may also represent the number 2. This symbol also has attached to it the meanings, boron and second.
d) The fourth alphabetical symbol which is the English letter; [symbol] c, which represents the sounds found in the words; code, ask, chord. This symbol may also represent the number 3 This symbol also has attached to it the meanings carbon and light speed.
e) The fifth alphabetical symbol which is the English letter; [symbol] d, which represents the sounds found in the words; do, wider, did. This symbol may also represent the number 4. This symbol also has attached to it the meanings down and diameter.
f) The sixth alphabetical symbol which is the English letter; [symbol] e, which represents the sounds found in the words; end, dead, said. This symbol may also represent the number 5. This symbol also has attached to it the meanings, energy and forces.
g) The seventh symbol which is a straight dash; [symbol] -, which represents the sounds found in the words; eel, sea, be. This symbol may also represent the number 6. This symbol also has attached to it the meanings, minus and subtract.
h) The eight symbol is a reversed and inverted J; [symbol] , which represents the sounds found in the words; for, often, off. This symbol may also represent the number 7. This symbol also has attached to it the meanings, fluorine and frequency.
i) The ninth symbol is the reversed “J”; [symbol] , which represents the sounds found in the words; go, buggy, dig. This symbol may also represent the number 8. This symbol also has attached to it the meanings, gauge and gallium.
j) The tenth symbol is the English letter H; [symbol] h, which represents the sounds found in the words; he, behave, ahead. This symbol may also represent the number 9. This symbol also has attached to it the meanings, hydrogen mag energy.
k) The eleventh alphabetical symbol which is the English letter I; [symbol] , which represents the sounds found in the words; in, bit, pity. This symbol may also represent the number 10. This symbol also has attached to it the meanings, iodine and immutable.
l) The twelfth symbol is a left hand circular bracket; [symbol] (, which represents the sounds found in the words; ice, buy, tie. This symbol may also represent the number 11. This symbol also has attached to it the meanings, I, me and mine.
m) The thirteenth symbol which is the English letter J; [symbol] J, which represents the sounds found in the words; jam, age, badge. This symbol may also represent the number 12. This symbol also has attached to it the meanings, justice and fair.
n) The fourteenth symbol is a left arrow; [symbol] <, which represents the sounds found in the words; chip, rich, itch. This symbol may also represent the number 13. This symbol also has attached to it the meanings, church and chief.
o) The fifteenth symbol is the English letter L: [symbol] L, which represents the sounds found in the words; low, silly, all. This symbol may also represent the number 14. This symbol also has attached to it the meanings Latitude.
p) The sixteenth symbol is the English letter M; [symbol] m, which represents the sounds found in the words; me, omen, tame. This symbol may also represent the number 15. This symbol also has attached to it the meanings meter, male and mister.
q) The seventeenth symbol is the English letter N; [symbol] n, which represents the sounds found in the words; no, any, bone. This symbol may also represent the number 16. This symbol also has attached to it the meanings number and nitrogen.
r) The eighteenth symbol is the English letter O; [symbol] o, which represents the sounds found in the words; old, boat, doe. This symbol may also represent the number 17. This symbol also has attached to it the meanings circle and sphere.
s) The nineteenth symbol is a curved right hand bracket; [symbol] ), which represents the sounds found in the words; on, awl, ball. This symbol may also represent the number 18. This symbol also has attached to it the meaning automatic.
t) The twentieth symbol is the English letter P; [symbol] , which represents the sounds found in the words; pet, ape, top. This symbol may also represent the number 19. This symbol also has attached to it the meanings per, power, pressure.
u) The twenty-first symbol is the English letter R; [symbol] , which represents the sounds found in the words; row, sorry, car. This symbol nay also represent the number 20. This symbol also has attached to it the meanings register and radius.
v) The twenty-second symbol is the English letter S; [symbol] S, which represents the sounds found in the words; ice, sea, ass. This symbol may also represent the number 21. This symbol also has attached to it the meanings second and satisfactory.
w) The twenty-third symbol is the English dollar sign; [symbol] $, which represents the sounds found in the words; motion, mission. This symbol may also represent the number 22. This symbol also has attached to the meanings quite and silence.
x) The twenty-fourth symbol is a plus sign or a cross; [symbol] +, which represents the sounds found in the words; to, auto, at. This symbol may also represent the number 23. This symbol also has attached to the meanings time and temperature.
y) The twenty-fifth symbol is the English letter U; [symbol] u, which represents the sounds found in the words; up, but, the. This symbol may also represent the number 24. This symbol also has attached to the meanings ultra and U=reverse or U-turn.
z) The twenty-sixth symbol which is the English letter V; [symbol] V, which represents the sounds found in the words; vile, avid, have. This symbol may also represent the number 25. This symbol also has attached to the meanings volts aid velocity.
aa) The twenty-seventh symbol is the English letter W; [symbol] w, which represents the sounds found in the words; we, away, bough. This symbol may also represent the number 26. This symbol also has attached to the meanings watt and west.
bb) The twenty-eight symbol which is the English letter X; [symbol] , which represents the sounds found in the words; exit, next, fix. This symbol may also represent the number 27. This symbol also has attached to the meanings unknown and multiply.
cc) The twenty-ninth symbol which is the English letter Y; [symbol] , which represents the sounds found in the words; you, beyond, unit. This symbol may also represent the number dd) This symbol also has attached to the meaning you.
ee) The thirtieth symbol which is the English letter Z; [symbol] , which represents the sounds found in the words; zoo, booze, is. This symbol may also represent the number 29. This symbol also has attached to the meaning end.

2. The communication means claimed in claim 1, wherein said alphabet symbols are used to form a computer operating language consisting of the global phonetic alphabet symbols.

3. The communication means claimed in claim 1 wherein said symbols are arranged together to form words wherein each word so formed has only one distinct meaning and one distinct sound.

4. The communication means claimed in claim 3 wherein said words compiled together form a global phonetic language.

5. The communication means claimed in claim 4 wherein said language is adapted for including voice recognition software for communicating orally with computers

6. The global communication means in claim 1, wherein said alphabet, and words, and language created from said alphabet; are used for communications between people, computers and machines, and by voice, writing, and keyboard, and by cable, wireless, and phone.
